(19) United States
(12) Patent Application Publication
(10) Pub. No.: US 2024/0088613 A1
(43) Pub. Date: Mar. 14, 2024

(54) Connector

(71) Applicant: Yazaki Corporation, Tokyo (JP)

(72) Inventors: Daisuke Yamanashi, Makinohara-shi (JP); Takashi Sone, Makinohara-shi (JP)

(21) Appl. No.: 18/361,358

(22) Filed: Jul. 28, 2023

(30) Foreign Application Priority Data
Sep. 14, 2022 (JP) 2022-145836

(51) Int. Cl. H01R 13/6581; H01R 13/621

(52) U.S. Cl. CPC H01R 13/6581; H01R 13/621

(57) ABSTRACT

A connector includes: a terminal fitting; a housing that houses the terminal fitting and allows a protruded part to protrude from a wall face of a metallic mating wall body; a shield shell that includes a shield main body that is placed over the protruded part, and a fixing part that has a bolt insertion hole formed coaxially with a female screw part of the mating wall body; a metallic bolt that is inserted into the bolt insertion hole to screw-fix the fixing part; and a bolt cap. The bolt cap includes: a cap main body that is placed over a head part to hide the head part; a holding body that is inserted into a holding hole of the fixing part to be closely fitted and held to the holding hole; and a connector body that connects the cap main body and the holding body.

### CROSS-REFERENCE TO RELATED APPLICATION(S)

The present application claims priority to and incorporates by reference the entire contents of Japanese Patent Application No. 2022-145836 filed in Japan on Sep. 14, 2022.

### BACKGROUND OF THE INVENTION

### 1. Field of the Invention

The present invention relates to a connector.

### 2. Description of the Related Art

A connector includes a metallic shield shell that is placed over a housing from the outside in order to suppress intrusion of external noise for terminal fittings and electric wires in the housing made of a synthetic resin. In such a connector, the shield shell is screwed and fixed to a metallic casing or the like of a mating side with a metallic bolt to release external noise on the shield shell through the casing or the like. Since the connector employs such a screw-locking structure, the head part of the bolt protrudes outward. Therefore, the conventional connector is provided with a bolt cap that is placed over the head part to suppress water exposure to the head part. The related technologies are described, for example, in: Japanese Patent Application Laid-open No. 2015-207385; Japanese Patent Application Laid-open No. 2013-54929; Japanese Patent Application Laid-open No. 2014-93289; Japanese Patent Application Laid-open No. 2015-17625; Japanese Patent Application Laid-open No. 2015-18615; and Japanese Patent Application Laid-open No. 2019-96472. For example, the connectors described in the technologies above are provided with a bolt cap that includes a cap main body that is placed over a head part of a bolt, and a co-fastening part that is fastened together by the bolt.

By the way, in the connector, because of the co-fastening part of the bolt cap interposed between the shield shell and a mating face of the bolt, the axial force of the bolt may be decreased, allowing water to penetrate between those three parts. The water may then enter the bolt insertion through-hole in the shield shell and flow to the mating side.

### SUMMARY OF THE INVENTION

It is therefore an object of the present invention to provide a connector that includes a bolt cap capable of suppressing deterioration of the waterproof performance.

In order to achieve the above mentioned object, a connector according to one aspect of the present invention includes a terminal fitting that is physically and electrically connected to a mating terminal fitting; a housing that houses the terminal fitting, and allows a protruded part to protrude from a wall face of a metallic mating wall body in a state of being fitted and connected to a mating fitting part; a shield shell that includes a shield main body that is placed over the protruded part of the housing from outside, and a fixing part that is in contact with the wall face of the mating wall body, the fixing part having a bolt insertion hole formed coaxially with a female screw part of the mating wall body; a metallic bolt that is inserted into the bolt insertion hole and screwed into the female screw part to screw-fix the fixing part to the mating wall body; and a bolt cap that is placed over a head part of the bolt, wherein the bolt cap includes: a cap main body that is placed over the head part to hide the head part; a holding body that is inserted into a holding hole of the fixing part from an inlet to be closely fitted and held to the holding hole; and a connector body that connects the cap main body and the holding body.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a perspective view illustrating a connector according to an embodiment;

FIG. 2 is a perspective view of the connector of the embodiment viewed from another angle along with a mating connector;

FIG. 3 is a plan view illustrating the connector according to the embodiment;

FIG. 4 is a sectional view taken along line X1-X1 in FIG. 3;

FIG. 5 is a sectional view taken along line X2-X2 in FIG. 3;

FIG. 6 is a perspective view illustrating a bolt cap according to the embodiment;

FIG. 7 is a partially enlarged view corresponding to the sectional view taken along line X2-X2 in FIG. 3, which illustrates a state before mounting the bolt cap;

FIG. 8 is a partially enlarged view corresponding to the sectional view taken along line X2-X2 in FIG. 3, which illustrates a state before fitting the bolt cap onto a head part;

FIG. 9 is a perspective view illustrating a connector according to a modification example;

FIG. 10 is a perspective view of the connector of the modification example viewed from another angle;

FIG. 11 is a sectional view taken along line X2-X2 in FIG. 9;

FIG. 12 is a perspective view illustrating a bolt cap according to the modification example;

FIG. 13 is a partially enlarged view corresponding to the sectional view taken along line X2-X2 in FIG. 9, which illustrates a state before mounting the bolt cap; and

FIG. 14 is a partially enlarged view corresponding to the sectional view taken along line X2-X2 in FIG. 9, which illustrates a state before fitting the bolt cap onto a head part.

### DETAILED DESCRIPTION OF THE PREFERRED EMBODIMENTS

Hereinafter, an embodiment of a connector according to the present invention will be described in detail with reference to the accompanying drawings. Note, however, that the present invention is not limited by the embodiment.

### Embodiment

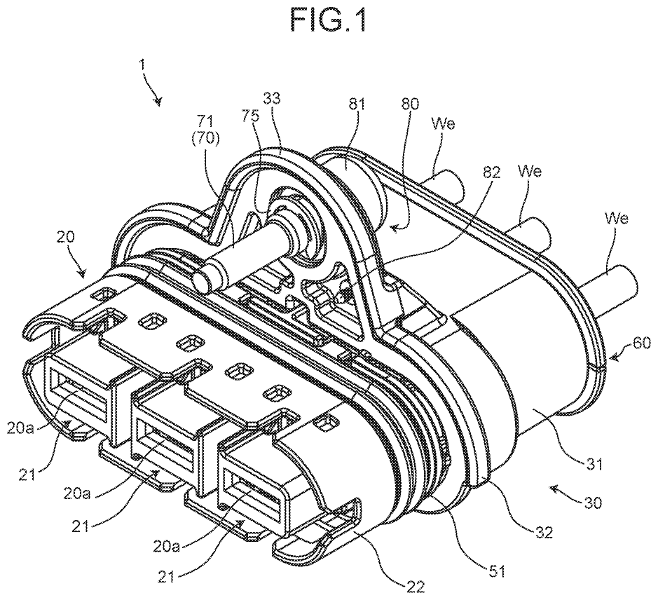

Hereinafter, one embodiment of the connector according to the present invention will be described with reference to FIG. 1 to FIG. 8.

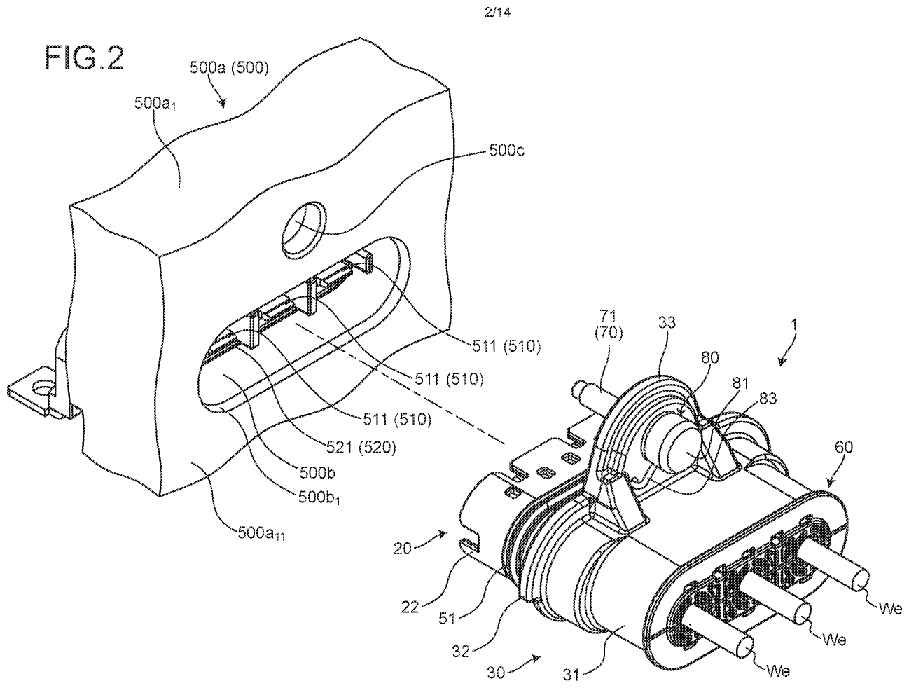

Reference sign 1 in FIG. 1 to FIG. 5 indicates a connector of the present embodiment. The connector 1 is attached to terminals of electric wires We, and electrically connected to a device (not illustrated) that is at the end of the electric wires We. Furthermore, the connector 1 is electrically connected to mating terminal fittings 510 of a mating device 500 (FIG. 2) to electrically connect the mating device 500 and the device at the end of the electric wires We. For example, herein, the device at the end of the electric wires We is an inverter of a vehicle, and the mating device 500 is a rotating machine of the vehicle.

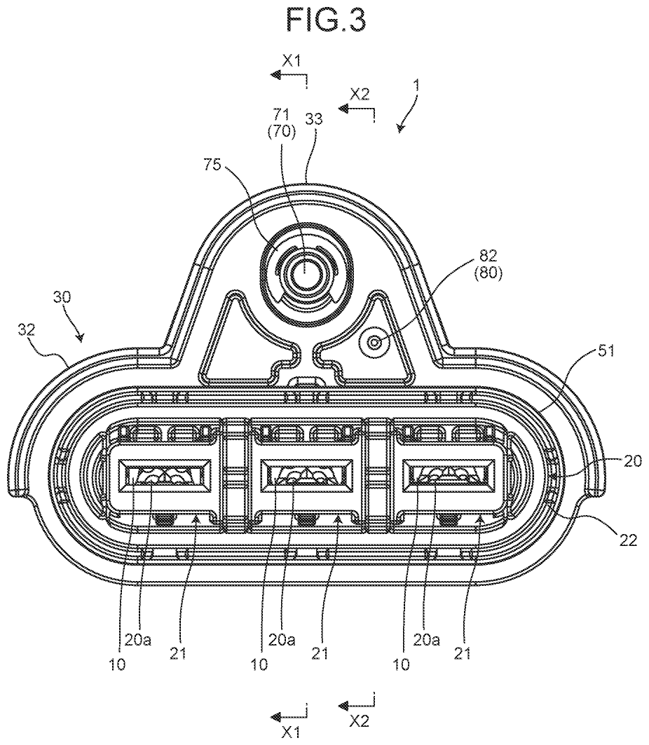

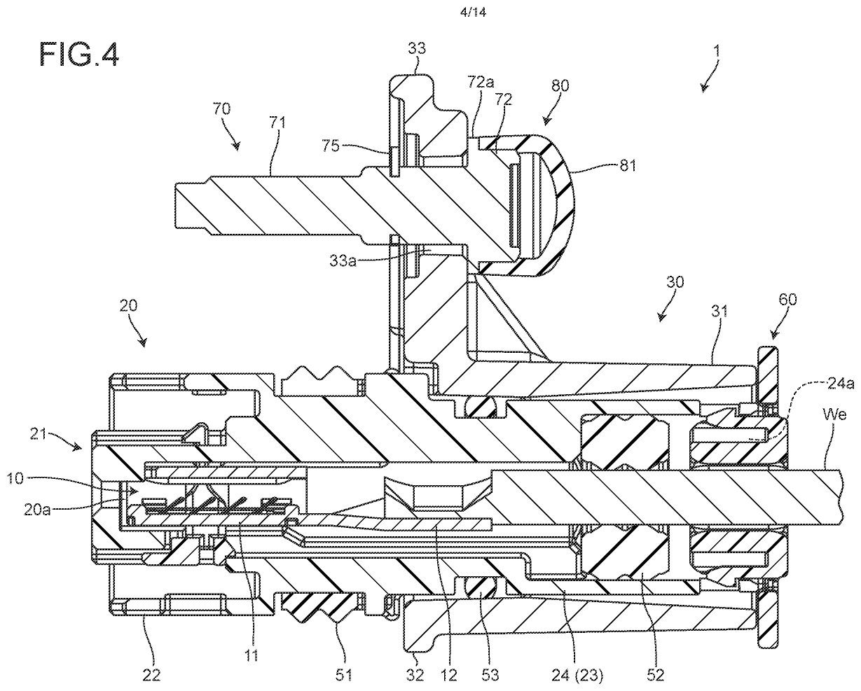

The connector 1 includes terminal fittings 10, a housing 20, and a shield shell 30 (FIG. 3 and FIG. 4).

The terminal fittings 10 are molded with a conductive material such as metal. For example, each of the terminal fitting 10 is molded into a prescribed shape by press molding such as bending and cutting performed on a metallic plate that is a base material. This terminal fitting 10 is attached to the terminal of the electric wire We to be electrically connected to the electric wire We. Furthermore, the terminal fitting 10 is physically and electrically connected to the mating terminal fitting 510. Thus, the terminal fitting 10 includes: a terminal connection part 11 that is physically and electrically connected to a mating terminal connection part 511 of the mating terminal fitting 510; and an electric wire connection part 12 that is physically and electrically connected to the terminal of the electric wire We (FIG. 4).

The terminal connection part 11 may, for example, be in a form to be fitted and connected to the mating terminal connection part 511 of the mating terminal fitting 510, or in a form to be screwed and fixed to the mating terminal connection part 511. The terminal connection part 11 according to the present embodiment is formed to be fitted and connected to the mating terminal connection part 511 in a fitting/connecting direction along a terminal insertion direction for the housing 20. Therefore, one of the terminal connection part 11 and the mating terminal connection part 511 is formed in a female terminal shape, and the other is formed in a male terminal shape.

The terminal connection part 11 discussed herein is formed in a tubular female terminal shape that allows the mating terminal connection part 511 to be inserted into a terminal removal direction from the housing 20. The terminal connection part 11 is formed, for example, in an angular tube shape or a circular tube shape. Herein, the terminal connection part 11 is formed in an angular tube shape. Therefore, the mating terminal connection part 511 described herein is formed as a single-body (so-called male tab) male terminal shape (FIG. 2).

The electric wire connection part 12 is physically and electrically connected to the core wire at the terminal of the electric wire We by, for example, crimping or welding. In the electric wire connection part 12 discussed herein, two barrel pieces are caulked and connected to the exposed core wire to be crimped to the core wire.

The terminal fitting 10 described as an example is molded in a straight shape where the terminal connection part 11 and the electric wire connection part 12 are disposed in a straight line. Thus, the electric wire We is drawn out from the electric wire connection part 12 in an extending direction of the terminal fitting 10 along the straight line. However, the terminal fitting 10 may have the terminal connection part 11 and the electric wire connection part 12 disposed in an intersecting manner, such as being disposed orthogonally.

The connector 1 discussed herein includes three pairs of a combination of the terminal fitting 10 and the electric wire We.

The housing 20 is molded with an insulating material such as a synthetic resin. The housing 20 allows the terminal fittings 10 and the electric wires We to be housed inside. Furthermore, in the housing 20, the terminal fittings 10 are held in the housed state, and the electric wires We are drawn outward from the inside.

In the housing 20, a terminal housing part 21 for housing the terminal fitting 10 inside a terminal housing chamber 20a is provided for each of the terminal fittings 10 (FIG. 1, FIG. 3, and FIG. 4). The terminal housing part 21 is formed in an angular tube shape, and the terminal connection part 11 in an angular tube shape is housed in the terminal housing chamber 20a formed on the inner side. Furthermore, in the terminal housing part 21, the mating terminal connection part 511 is inserted into the terminal housing chamber 20a from one of the openings in the cylinder axis direction, and the mating terminal connection part 511 is inserted into the terminal connection part 11 inside the terminal housing chamber 20a.

The housing 20 includes a cylindrical hood part 22 that covers each of the terminal housing parts 21 from the outside with a space provided therebetween (FIG. 1 to FIG. 5). The hood part 22 discussed herein is formed in an elliptic cylindrical shape. In the housing 20, an elliptic cylindrical mating terminal housing part 521 of a mating housing 520 (FIG. 2) is fitted into an elliptic annular gap between the hood part 22 and each of the terminal housing parts 21 and, along with that, each of the mating terminal connection part 511 inside the mating terminal housing part 521 is inserted into the respective terminal housing chamber 20a. Therefore, in the housing 20, the hood part 22 and each of the terminal housing parts 21 serve as a fitting part, and the fitting part is fitted and connected to the mating terminal housing part 521 as a mating fitting part.

Here, the mating housing 520 is fixed to a metallic casing 500a of the mating device 500, and it is disposed in an elliptic-shaped through-hole 500b in a mating wall body 500a₁ of the casing 500a (FIG. 2). In the connector 1, the hood part 22 of the housing 20 is inserted from an insertion port 500b₁ of the through-hole 500b. The housing 20 has an elliptic cylindrical seal member 51 mounted onto an elliptic outer peripheral face positioned on the insertion port 500b₁ side in the through-hole 500b (FIG. 1 to FIG. 5). The seal member 51 is a waterproof member that fills part of the elliptic cylindrical gap between the elliptic outer peripheral face of the housing 20 and the inner peripheral face of the through-hole 500b in the casing 500a.

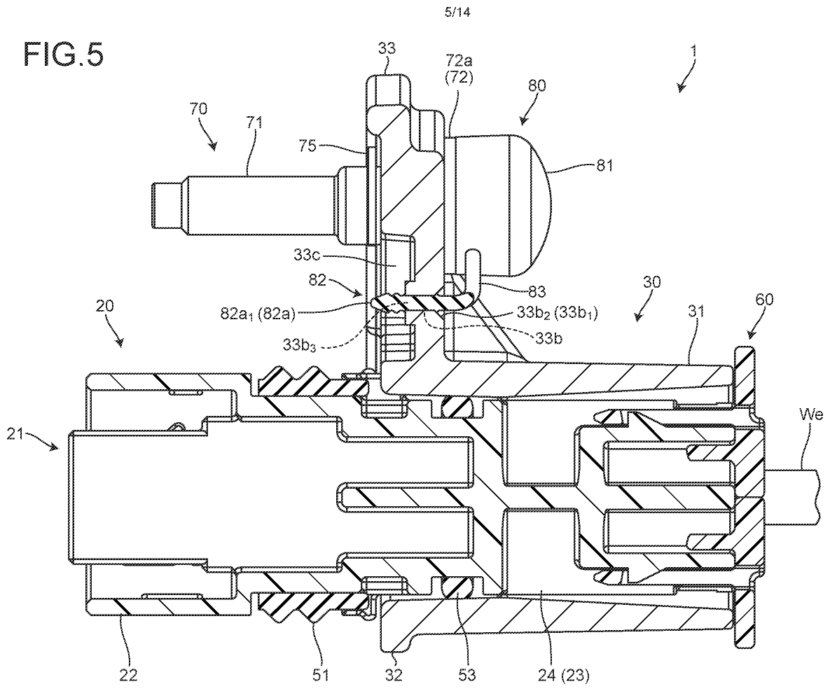

The housing 20 has a protruded part 23 that protrudes from a wall face 500a₁₁ on the insertion port 500b₁ side of the mating wall body 500a₁ (FIG. 4 and FIG. 5) in a state where the hood part 22 and the seal member 51 are housed in the through-hole 500b (that is, in a state where the hood part 22 and each of the terminal housing parts 21 as the fitting part are fitted and connected to the mating terminal housing part 521 as the mating fitting part (hereinafter referred to as “fitted/connected state”)). The protruded part 23 includes an electric wire housing part 24 of the housing 20.

The electric wire housing part 24 is a cylindrical portion of the housing 20 that allows the electric wire We to be housed inside and drawn outside, and it is provided for each of the electric wires We. Inside the electric wire housing part 24, a cylindrical seal member 52 is mounted for partially filling the cylindrical gap between the inner peripheral face thereof and the outer peripheral face of the electric wire We (FIG. 4). The terminal fitting 10 attached to the terminal of the electric wire We is inserted from an electric wire outlet port 24a of the electric wire housing part 24 to the terminal housing chamber 20a. The connector 1 includes a rear holder 60 that is fitted into the gap between the electric wire outlet port 24a of each of the electric wire housing parts 24 and the electric wire We (FIG. 1, FIG. 2, FIG. 4, and FIG. 5).

The shield shell 30 covers the protruded part 23 of the housing 20 from the outside to suppress intrusion of the external noise for the electric wire We inside each of the electric wire housing parts 24. Therefore, the shield shell 30 is molded with a metallic material (for example, aluminum or aluminum alloy).

The shield shell 30 includes an elliptic cylindrical shield main body 31 that is placed over the protruded part 23 of the housing 20 from the outside (FIG. 1 to FIG. 5). In the housing 20, an elliptic annular seal member 53 is mounted onto an elliptic outer peripheral face positioned on the hood part 22 side than to each of the electric wire housing parts 24 side in the protruded part 23 (FIG. 4 and FIG. 5). The seal member 53 is a waterproof member that fills part of the elliptic cylindrical gap between the elliptic outer peripheral face of the housing 20 and the inner peripheral face of the shield main body 31 of the shield shell 30.

The shield shell 30 includes an elliptic annular flange part 32 that is provided at one end of the shield main body 31 in the cylinder axis direction and is brought in contact with the wall face 500a₁₁ on the insertion port 500b₁ side of the mating wall body 500a₁ in the fitted/connected state (FIG. 1 to FIG. 5). The shield shell 30 has a fixing part 33 that protrudes from the flange part 32 and is brought in contact with the wall face 500a₁₁ on the insertion port 500b₁ side of the mating wall body 500a₁ in the fitted/connected state (FIG. 1 to FIG. 5). In the fixing part 33, a through-hole (hereinafter referred to as “bolt insertion hole”) 33a is disposed coaxially with a female screw part 500c of the mating wall body 500a₁ in the fitted/connected state (FIG. 4).

The connector 1 includes a metallic bolt 70 that is inserted into the bolt insertion hole 33a and screwed into the female screw part 500c to screw and fix the fixing part 33 to the mating wall body 500a₁ (FIG. 1 to FIG. 5). The bolt 70 includes: a male screw part 71 that is inserted into the bolt insertion hole 33a and screwed into the female screw part 500c in the fitted/connected state; and a head part 72 that receives torque about the axis from a tool (not illustrated) when screwed (FIG. 4 and FIG. 5). The connector 1 includes a snap ring 75 that rotatably holds the bolt 70 around the axis with respect to the fixing part 33, while the male screw part 71 is being inserted into the bolt insertion hole 33a (FIG. 1, and FIG. 3 to FIG. 5).

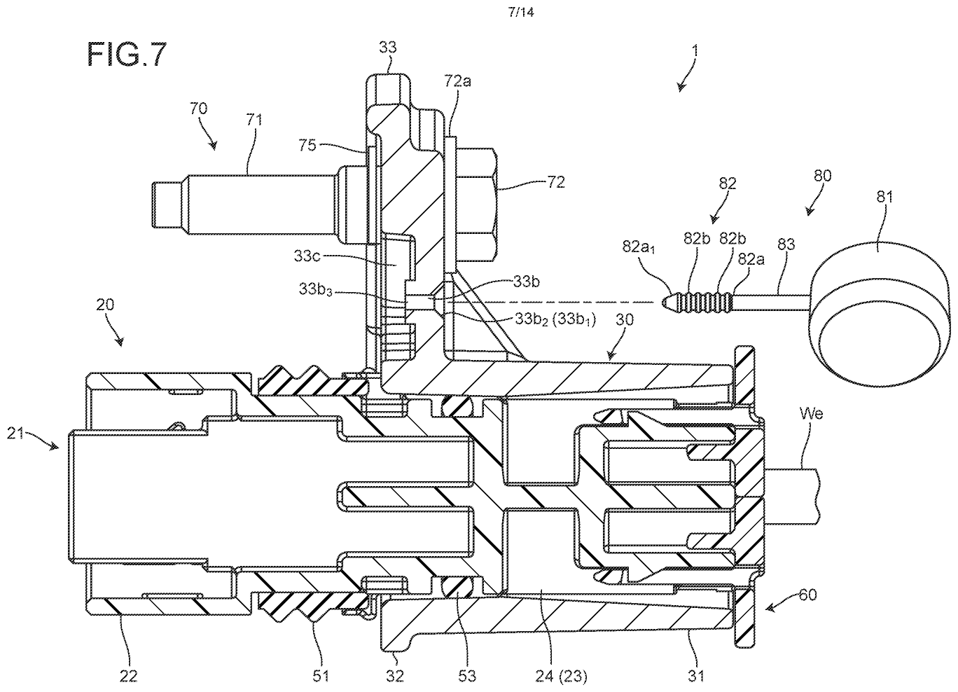

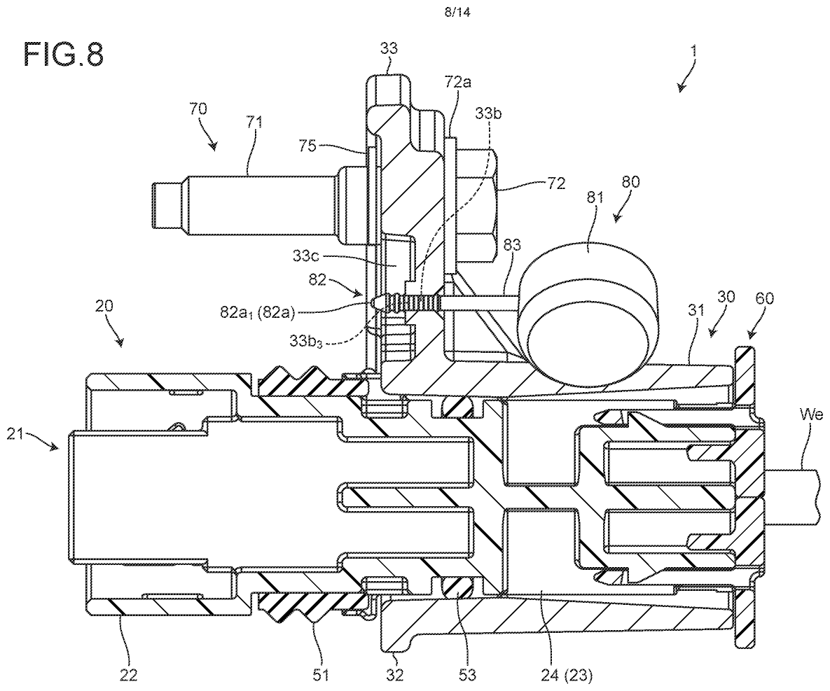

In the connector 1, the head part 72 of the bolt 70 protrudes outward, and a liquid such as water may be attached to the head part 72 depending on the installation place. Therefore, the connector 1 includes a bolt cap 80 that is placed over the head part 72 (FIG. 1 to FIG. 8). The bolt cap 80 is molded with a flexible material such as synthetic rubber. Note that in FIG. 7 and FIG. 8, the bolt cap 80 is not illustrated as a cross-sectional view for convenience of explanation.

The bolt cap 80 includes: a cap main body 81 that is placed over the head part 72 to hide the head part 72; a holding body 82 that is inserted into a through-hole (hereinafter referred to as “holding hole”) 33b of the fixing part 33 from an inlet 33b₁ to be closely fitted and held to the holding hole 33b; and a connector body 83 that connects the cap main body 81 and the holding body 82 (FIG. 1 to FIG. 8).

The cap main body 81 is formed in a cylindrical shape with one end being closed and the other end being opened, and the head part 72 of the bolt 70 is inserted from the opening. The cap main body 81 is formed in a cylindrical shape by corresponding to the head part 72. The cap main body 81 discussed herein is formed in a cylindrical shape with one end being closed in accordance with the shape of the head part 72 of the hexagon bolt. Furthermore, as for the cap main body 81 discussed herein, the annular end face of the opening side is closely fitted with an annular mating part 72a of the head part 72 to suppress intrusion of a liquid from between the end face and the mating part 72a (FIG. 4 and FIG. 5).

The holding body 82 and the connector body 83 are formed as a bendable shaft shape capable of protruding and extending from the outer peripheral face of the cap main body 81. The holding body 82 discussed herein includes an insertion part 82a that is inserted into the holding hole 33b by inserting its tip 82a₁ from the inlet 33b₁ of the holding hole 33b (FIG. 5 to FIG. 8). Herein, the insertion part 82a and the connector body 83 are formed as a cylindrical shaft.

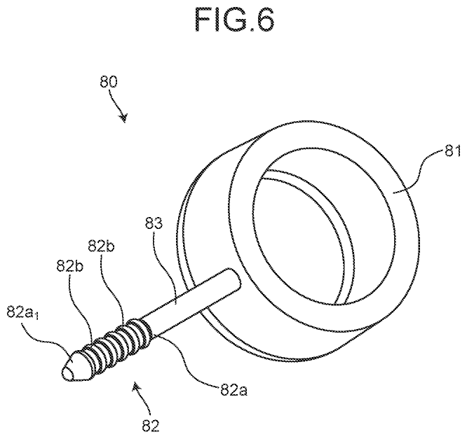

The holding body 82 is inserted into the cylindrical holding hole 33b of the fixing part 33 in a closely fitted state to be held in the inner peripheral face of the holding hole 33b and to close the gap therebetween, thereby improving the waterproof performance. Therefore, the holding body 82 is placed to be closely fitted around the whole inner peripheral face of the holding hole 33b. Thus, the holding body 82 includes a lip part 82b that is disposed concentrically on the outer peripheral face of the insertion part 82a and is closely fitted around the whole inner peripheral face of the holding hole 33b (FIG. 6 and FIG. 7). The lip part 82b discussed herein is formed in an annular shape, and a plurality of those are disposed with a space provided therebetween along the axial direction of the insertion part 82a.

The holding body 82 is held in the holding hole 33b of the fixing part 33 using the lip parts 82b. Furthermore, the holding body 82 uses the lip parts 82b to close the annular gap between the outer peripheral face of the insertion part 82a and the inner peripheral face of the holding hole 33b, thereby suppressing the passage of a liquid therebetween.

As for the bolt cap 80, the tip 82a₁ of the insertion part 82a is inserted into the holding hole 33b from the inlet 33b₁. Thus, the insertion operability of the insertion part 82a for the holding hole 33b is improved herein as follows. First, in the inlet 33b₁ of the holding hole 33b, a chamfered part 33b₂ is provided by chamfering around the whole peripheral edge of the inlet 33b₁ (FIG. 5 and FIG. 7). Then, the tip 82a₁ of the insertion part 82a is formed into a cone shape with a pointed tip. In other words, the inlet 33b₁ of the holding hole 33b discussed herein is formed in a conical trapezoidal shape with a larger diameter on the outside. Furthermore, the tip 82a₁ of the insertion part 82a discussed herein is formed in a cone shape. This allows the bolt cap 80 to improve the insertion operability of the insertion part 82a for the holding hole 33b.

Furthermore, as for the bolt cap 80, the holding body 82 is inserted into the holding hole 33b by inserting the tip 82a₁ of the insertion part 82a into the holding hole 33b from the inlet 33b₁ and allowing the tip 82a₁ to protrude from an outlet 33b₃ of the holding hole 33b (FIG. 5, FIG. 7, and FIG. 8). In order to prevent the tip 82a₁ of the insertion part 82a slipped out of the outlet 33b₃ of the holding hole 33b from abutting against the wall face 500a₁₁ on the insertion port 500b₁ side of the mating wall body 500a₁ in the fitted/connected state, a recessed part 33c is provided in the fixing part 33 for housing the tip 82a₁ between the wall face 500a₁₁ and the outlet 33b₃ (FIG. 5, FIG. 7, and FIG. 8). The recessed part 33c is a recessed portion of the wall face on the wall face 500a₁₁ side of the fixing part 33, inside which the outlet 33b₃ of the holding hole 33b is disposed. The outlet 33b₃ is disposed at a position that is spaced from the wall face 500a₁₁ in the fitted/connected state and at a position where the slipped-out tip 82a₁ does not come in contact with the wall face 500a₁₁ in the fitted/connected state. This allows the bolt cap 80 to suppress the load applied from the wall face 500a₁₁ to the holding body 82 toward the inlet 33b₁ side, thereby making it possible to maintain the holding function of the holding hole 33b by the holding body 82.

Furthermore, as for the bolt cap 80, after completing the screwing operation of the bolt 70 in the fitted/connected state, the cap main body 81 is placed over the head part 72 of the bolt 70 while bending the connector body 83.

As described above, the connector 1 according to the present embodiment can suppress water exposure to the head part 72 of the bolt 70 by the bolt cap 80, so that it is possible to improve the durability of the head part 72. Furthermore, with the connector 1, by inserting the holding body 82 into the holding hole 33b of the fixing part 33 in a closely fitted state, it is possible to suppress deterioration of the waterproof performance by holding the holding body 82 to the inner peripheral face of the holding hole 33b and sealing the gap between the inner peripheral face and the holding body 82. Furthermore, the connector 1 can improve the insertion operability of the holding body 82 for the holding hole 33b since the chamfered part 33b₂ of the inlet 33b₁ of the holding hole 33b and the cone shape of the tip 82a₁ of the insertion part 82a helps catch the holding body 82 to be inserted into the holding hole 33b. Furthermore, the connector 1 covers the head part 72 of the bolt 70 with the bolt cap 80, thereby contributing to improving the appearance. In addition, since the connector 1 only needs to place the cap main body 81 over the head part 72 of the bolt 70 and no specific shape for the bolt cap 80 needs to be provided in the bolt 70 for providing the bolt cap 80, it is possible to use the bolt 70 of a versatile standard product.

### Modification Example

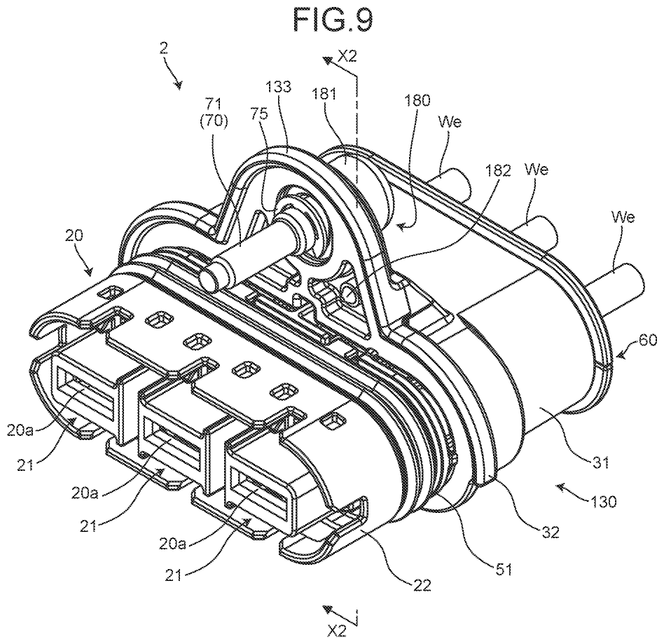

In a connector 2 according to a modification example, the shield shell 30 and the bolt cap 80 of the connector 1 according to the embodiment described above are replaced by a shield shell 130 and a bolt cap 180 described below (FIG. 9 to FIG. 14). For this reason, in the following, same reference signs are applied as necessary to components and parts that are unchanged from those of the embodiment as well as components and parts that can be regarded as equivalent to those of the embodiment, and explanation thereof is omitted herein. Also, the reference signs in the drawings are omitted as necessary.

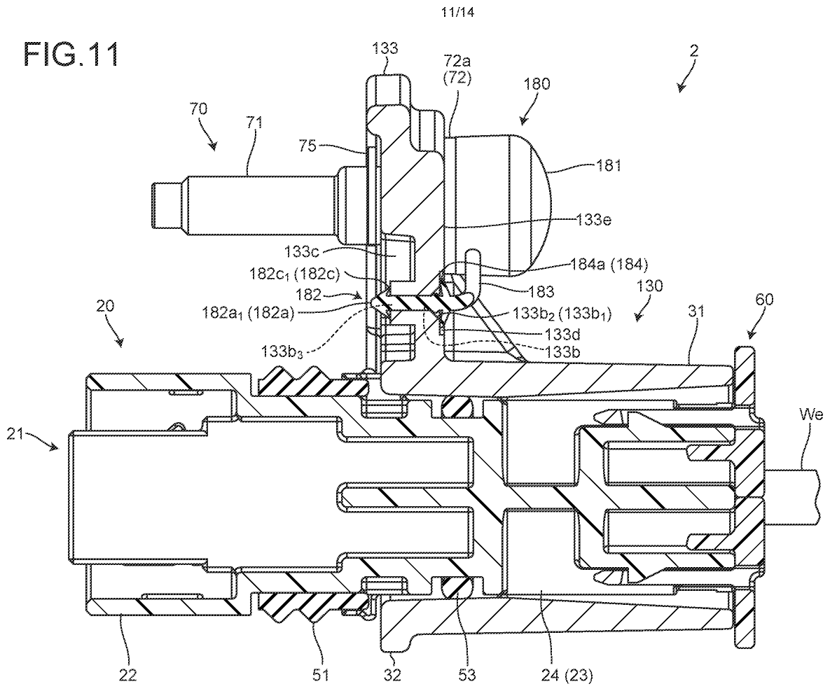

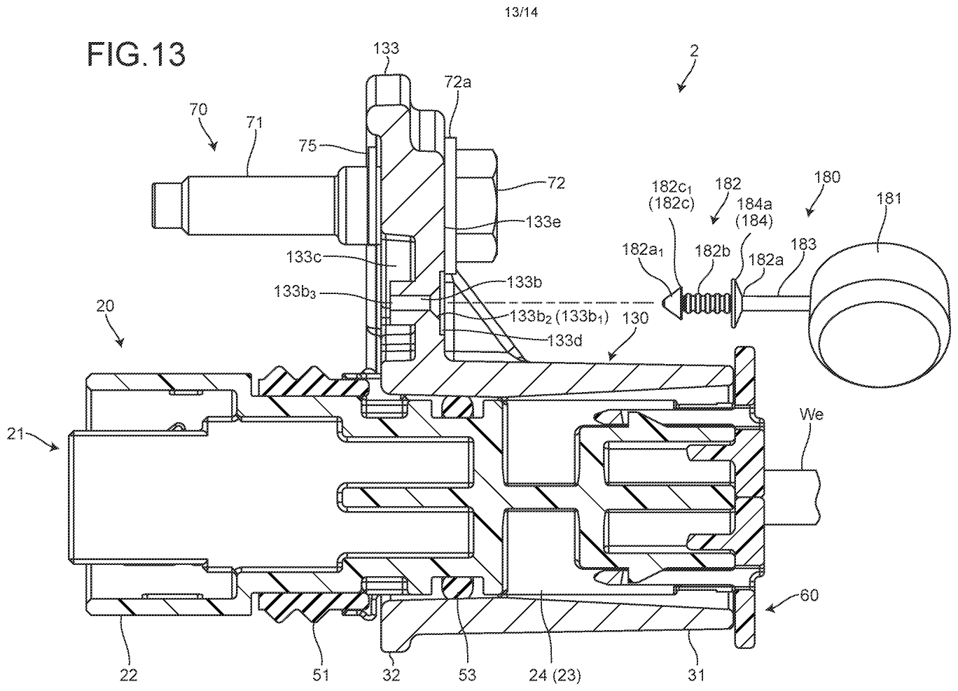

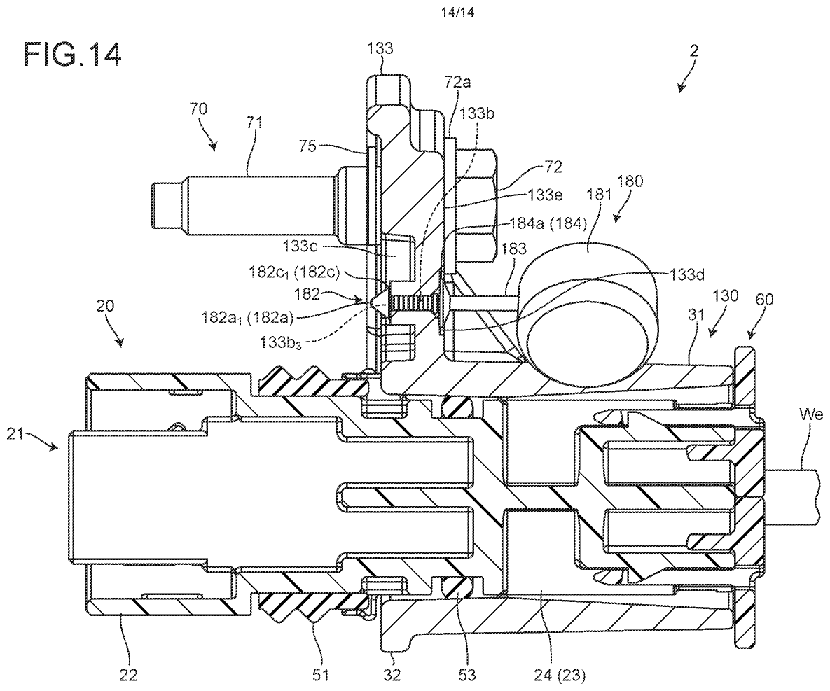

The shield shell 130 according to the modification example corresponds to the shield shell 30 of the embodiment described above, in which the fixing part 33 is replaced by a fixing part 133 described below (FIG. 9 to FIG. 11, FIG. 13, and FIG. 14). The fixing part 133 according to the modification example includes a bolt insertion hole 33a, a holding hole 133b, and a recessed part 133c similar to those of the fixing part 33 of the embodiment described above (FIG. 11, FIG. 13, and FIG. 14). The holding hole 133b includes a chamfered part 133b₂ of an inlet 133b₁ similar to those of the holding hole 33b of the embodiment described above (FIG. 11 and FIG. 13).

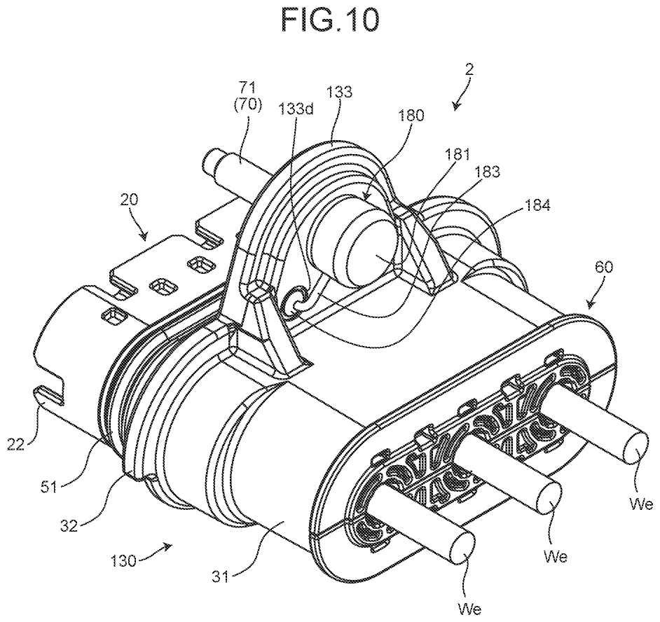

In the meantime, unlike the fixing part 33 of the embodiment described above, the fixing part 133 according to the modification example includes a counterbored part 133d where an annular end 184a of a covering part 184 to be described below of the bolt cap 180 comes to be in annular surface-contact by suppressing the gap (FIG. 10, FIG. 11, FIG. 13, and FIG. 14).

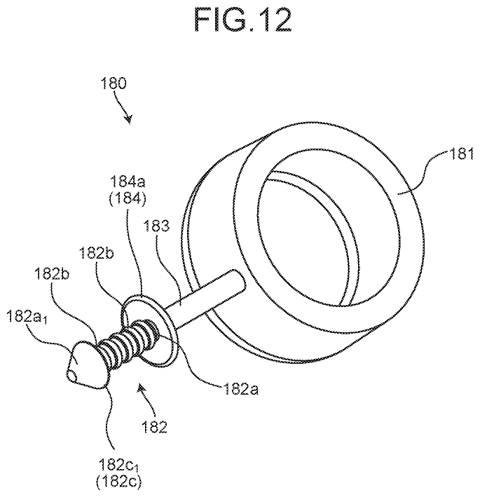

Here, the bolt cap 180 according to the modification example includes a cap main body 181, a holding body 182, and a connector body 183 similar to those of the bolt cap 80 of the embodiment described above (FIG. 11 to FIG. 14). Furthermore, the holding body 182 includes an insertion part 182a and a lip part 182b similar to those of the holding body 82 of the embodiment described above (FIG. 12 and FIG. 13).

In the meantime, unlike the bolt cap 80 of the embodiment described above, the bolt cap 180 according to the modification example includes the covering part 184 that is closely fitted to the peripheral edge of an inlet 133b₁ in an outer wall 133e of the fixing part 133 on the inlet 133b₁ side, and covers the inlet 133b₁ (FIG. 10 to FIG. 14). The covering part 184 is provided to suppress intrusion of a liquid into the inlet 133b₁, and it is formed in a conical umbrella shape that is coaxial with the insertion part 182a and the connector body 183. The covering part 184 is disposed at the boundary between the holding body 182 and the connector body 183. The covering part 184 suppress intrusion of a liquid from the peripheral edge to the inlet 133b₁ by closely fitting the annular end 184a on the lower bottom side to the peripheral edge of the inlet 133b₁ in the outer wall 133e of the fixing part 133 (FIG. 11 and FIG. 14). The peripheral edge is provided herein on the bottom face of the counterbored part 133d.

The counterbored part 133d is a circularly counterbored recessed part coaxially with the holding hole 133b with respect to the outer wall 133e of the fixing part 133 on the inlet 133b₁ side, and the inlet 133b₁ of the holding hole 133b is disposed on the bottom face thereof. In the counterbored part 133d, the bottom face is finished to have a surface roughness smaller than the surface roughness of the wall face of the outer wall 133e of the fixing part 133. This allows the annular end 184a of the covering part 184 to be in annular surface-contact with the bottom face of the counterbored part 133d by suppressing the gap. Thus, with the connector 2, the generation of the gap between the bottom face of the counterbored part 133d and the annular end 184a of the covering part 184 is suppressed, so that it is possible to improve the waterproof property therebetween.

Furthermore, the bolt cap 180 according to the modification example also differs from the bolt cap 80 of the embodiment described in the following respects. The holding body 182 according to the modification example includes a locking part 182c that is provided at a tip 182a₁ of the insertion part 182a and formed in an umbrella shape with a pointed tip (FIG. 11 to FIG. 14). The locking part 182c is engaged with the wall face of the fixing part 133 on an outlet 133b₃ side at the end through the outlet 133b₃ of the holding hole 133b. The locking part 182c discussed herein is formed in a conical umbrella shape that is coaxial with the insertion part 182a, and an annular end 182ci on the bottom part side is engaged with the wall face of the fixing part 133 on the outlet 133b₃ side, which is the peripheral edge of the outlet 133b₃ (FIG. 11 and FIG. 14). The bolt cap 180 according to the modification example can improve the holding force for the fixing part 133 by the locking part 182c.

Note here that the locking part 182c is in a conical shape with a pointed tip same as the tip 82a₁ of the insertion part 82a of the embodiment described above. Therefore, like the bolt cap 80 of the embodiment described above, the bolt cap 180 according to the modification example can improve the insertion operability of the insertion part 182a for the holding hole 133b since the chamfered part 133b₂ of the inlet 133b₁ of the holding hole 133b and the cone shape of the locking part 182c helps insertion.

As described above, the connector 2 according to the modification example has the same effect as that of the connector 1 according to the embodiment. Furthermore, the connector 2 according to the modification example can secure the waterproof property more than the case of the connector 1 according to the embodiment by the covering part 184 of the bolt cap 180, and can secure the holding force of the bolt cap 180 more than the case of the connector 1 according to the embodiment by the locking part 182c.

The connector according to the present embodiment can suppress water exposure to the head part of the bolt by the bolt cap, so that it is possible to improve the durability of the head part. Furthermore, with the connector, by inserting the holding body into the holding hole of the fixing part in a closely fitted state, it is possible to suppress deterioration of the waterproof performance by holding the holding body to the inner peripheral face of the holding hole and sealing the gap between the inner peripheral face and the holding body.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A connector comprising:
a terminal fitting that is physically and electrically connected to a mating terminal fitting;
a housing that houses the terminal fitting, and allows a protruded part to protrude from a wall face of a metallic mating wall body in a state of being fitted and connected to a mating fitting part;
a shield shell that includes a shield main body that is placed over the protruded part of the housing from outside, and a fixing part that is in contact with the wall face of the mating wall body, the fixing part having a bolt insertion hole formed coaxially with a female screw part of the mating wall body;
a metallic bolt that is inserted into the bolt insertion hole and screwed into the female screw part to screw-fix the fixing part to the mating wall body; and
a bolt cap that is placed over a head part of the bolt, wherein
the bolt cap includes: a cap main body that is placed over the head part to hide the head part; a holding body that is inserted into a holding hole of the fixing part from an inlet to be closely fitted and held to the holding hole; and a connector body that connects the cap main body and the holding body.

2. The connector according to claim 1, wherein the holding body includes a lip part that is closely fitted around a whole inner peripheral face of the holding hole.

3. The connector according to claim 1, wherein
the holding body includes an insertion part that is inserted into the holding hole by inserting a tip from the inlet of the holding hole,
the inlet of the holding hole has a chamfered part chamfered around a whole peripheral edge of the inlet, and
the tip of the insertion part is formed in a pointed cone shape.

4. The connector according to claim 2, wherein
the holding body includes an insertion part that is inserted into the holding hole by inserting a tip from the inlet of the holding hole,
the inlet of the holding hole has a chamfered part chamfered around a whole peripheral edge of the inlet, and
the tip of the insertion part is formed in a pointed cone shape.

5. The connector according to claim 1, wherein
the holding body includes: an insertion part that is inserted into the holding hole by inserting a tip from the inlet of the holding hole; and a locking part that is provided at the tip of the insertion part, the locking part being formed in an umbrella shape with a pointed tip, and
at an end through an outlet of the holding hole, the locking part is engaged with a wall face of the fixing part on the outlet side.

6. The connector according to claim 2, wherein
the holding body includes: an insertion part that is inserted into the holding hole by inserting a tip from the inlet of the holding hole; and a locking part that is provided at the tip of the insertion part, the locking part being formed in an umbrella shape with a pointed tip, and
at an end through an outlet of the holding hole, the locking part is engaged with a wall face of the fixing part on the outlet side.

7. The connector according to claim 1, wherein the bolt cap includes a covering part that is closely fitted to a peripheral edge of the inlet in an outer wall of the fixing part on the inlet side, the covering part covering over the inlet.

8. The connector according to claim 2, wherein the bolt cap includes a covering part that is closely fitted to a peripheral edge of the inlet in an outer wall of the fixing part on the inlet side, the covering part covering over the inlet.
